(19) United States
(12) Patent Application Publication
(10) Pub. No.: US 2011/0261389 A1
(43) Pub. Date: Oct. 27, 2011

(54) WIRELESS COMMUNICATION SYSTEM AND CONTROL METHOD THEREOF, IMAGE INPUT/OUTPUT APPARATUS AND CONTROL METHOD THEREOF, AND STORAGE MEDIUM

(75) Inventor: Eiji Ohara, Kawasaki-shi (JP)

(73) Assignee: CANON KABUSHIKI KAISHA, Tokyo (JP)

(21) Appl. No.: 12/674,382

(22) PCT Filed: Aug. 6, 2008
(86) PCT No.: PCT/JP2008/064604

§ 371 Date: Feb. 19, 2010

(30) Foreign Application Priority Data
Aug. 20, 2007 (JP) 2007-213841

(51) Int. Cl. G06F 3/12

(52) U.S. Cl. 358/1.15

(57) ABSTRACT

A wireless communication system capable of selecting a wireless communication means most suitable for the user's usage environment among multiple wireless communication means, thereby improving user convenience. A wireless communication is established between a cellular phone 300 and a MFP 200 with a proximity wireless communication means among the multiple wireless communication means, and an identification information table is generated and stored that includes identification information of a common wireless communication means capable of data communication among the multiple wireless communication means provided by the MFP 200. A job executed in cooperation with the cellular phone 300 is started upon the establishment of the wireless communication. Apparatus information of the cellular phone 300 is obtained at the time of starting the job. The obtained apparatus information and the identification information table are compared, and the wireless communication means for performing the data communication is selected according to the comparison result.

### TECHNICAL FIELD

The present invention relates to a wireless communication system that performs data communication between a wireless communication terminal having multiple wireless communication methods and an image input/output apparatus, wherein the most suitable wireless communication method is selected from the multiple wireless communication methods and a control method thereof, an image input/output apparatus and a control method thereof, and a storage medium storing a program for executing the control method.

### BACKGROUND ART

Regarding an electronic device performing various data communications via wireless communication, an electronic device is conventionally disclosed that has multiple different wireless communication schemes within one piece of casing and performs data transmission in either of the wireless communication scheme (see, for example, Japanese Laid-Open Patent Publication (Kokai) No. 2003-169375). It should be noted that the electronic device mentioned here includes a cellular phone, a PDA (Personal Digital Assistant), a notebook computer, and the like. In such conventional electronic devices, the wireless communication scheme is not specified by a user, but a priority order is previously set that is a determination criteria based on which the wireless communication scheme is specified. In such case, when the user transmits data, the user specifies the priority order thereof, and the wireless communication scheme is automatically selected according to the specified priority order, and the data communication is thus performed. The priority order may include a scheme consuming low electric power, a scheme having a short communication capable range, a scheme having fast communication speed, a scheme of inexpensive communication fee, and the like.

In the prior art technology as described above, although the priority order of the wireless communication scheme is previously configured, it is unknown what kind of wireless communication schemes are available in the other apparatus with which the wireless communication is performed. Accordingly, it is necessary to try to transmit data according to the communication schemes from the highest priority order one by one to find out the communication scheme according to which the data can be transmitted normally. The prior art technology as described above differentiates the priority orders of the preferred communication schemes according to the size of data to be transmitted, but is unable to take into consideration a condition other than the size of data to determine the most suitable communication scheme. Thus, the prior art technology as described above cannot select the most suitable communication method.

The present invention is made in consideration of the above-described problems, and it is an object of the present invention to provide a wireless communication system and an image input/output apparatus which is capable of selecting the most suitable wireless communication method from among multiple wireless communication methods according to a user's usage environment, thereby improving user convenience. Furthermore, it is an object of the present invention to provide a control method of the wireless communication system, a control method of the image input/output apparatus, and a storage medium.

### DISCLOSURE OF INVENTION

To attain the above object, a first aspect of the present invention, there is provided a wireless communication system wirelessly communicating between a wireless communication terminal capable of wireless communication according to a plurality of types of wireless communication methods and an image input/output apparatus capable of wireless communication according to the plurality of types of wireless communication methods, the wireless communication system comprising a generation unit adapted to generate information relating to a common wireless communication method that both of the wireless communication terminal and the image input/output apparatus provide, and a selection unit adapted to select, in a case where an instruction is received that instructs to execute a job to be executed by the image input/output apparatus and the wireless communication terminal in cooperation with each other, at least one of the wireless communication methods used for executing the job, based on at least one of information relating to a type of the job and information relating to the wireless communication terminal and based on information relating to the common wireless communication method generated by the generation unit.

To attain the above object, in a second aspect of the present invention, there is provided a control method of controlling a wireless communication system wirelessly communicating between a wireless communication terminal capable of wireless communication according to a plurality of types of wireless communication methods and an image input/output apparatus capable of wireless communication according to the plurality of types of wireless communication methods, the control method comprising a generation step of generating information relating to a common wireless communication method that both of the wireless communication terminal and the image input/output apparatus provide, a selection step of selecting, in a case where an instruction is received that instructs to execute a job to be executed by the image input/output apparatus and the wireless communication terminal in cooperation with each other, at least one of the wireless communication methods used for executing the job based on at least one of information relating to a type of the job and information relating to the wireless communication terminal and based on information relating to the common wireless communication method generated in the generation step.

To attain the above object, in a third aspect of the present invention, there is provided an image input/output apparatus capable of wireless communication according to a plurality of types of wireless communication methods, the image input/output apparatus wirelessly communicating with a wireless communication terminal capable of wireless communication according to the plurality of types of wireless communication methods, the image input/output apparatus comprising a generation unit adapted to generate information relating to a common wireless communication method that both of the wireless communication terminal and the image input/output apparatus provide, and a selection unit adapted to select, in a case where an instruction is received that instructs to execute a job to be executed in cooperation with the wireless communication terminal, at least one of the wireless communication methods used for executing the job, based on at least one of information relating to a type of the job and information relating to the wireless communication terminal and based on information relating to the common wireless communication method generated by the generation unit.

To attain the above object, in a fourth aspect of the present invention, there is provided a control method of controlling an image input/output apparatus capable of wireless communication according to a plurality of types of wireless communication methods, the image input/output apparatus wirelessly communicating with a wireless communication terminal capable of wireless communication according to the plurality of types of wireless communication methods, the control method comprising a generation step of generating information relating to a common wireless communication method that both of the wireless communication terminal and the image input/output apparatus provide, and a selection step of selecting, in a case where an instruction is received that instructs to execute a job to be executed in cooperation with the wireless communication terminal, at least one of the wireless communication methods used for executing the job, based on at least one of information relating to a type of the job and information relating to the wireless communication terminal and based on information relating to the common wireless communication method generated by the generation step.

To attain the above object, in a fifth aspect of the present invention, there is provided a computer readable storage medium storing a program for causing a computer to execute a control method of controlling an image input/output apparatus capable of wireless communication according to a plurality of types of wireless communication methods, the image input/output apparatus wirelessly communicating with a wireless communication terminal capable of wireless communication according to the plurality of types of wireless communication methods, the control method comprising a generation step of generating information relating to a common wireless communication method that both of the wireless communication terminal and the image input/output apparatus provide, and a selection step of selecting, in a case where an instruction is received that instructs to execute a job to be executed in cooperation with the wireless communication terminal, at least one of the wireless communication methods used for executing the job, based on at least one of information relating to a type of the job and information relating to the wireless communication terminal and based on information relating to the common wireless communication method generated by the generation step.

The above and other features and advantages of the present invention will be apparent from the following description taken in conjunction with the accompanying drawings, in which like reference characters designate the same name or similar parts throughout the figures thereof.

### BRIEF DESCRIPTION OF DRAWINGS

FIG. 1 is a view schematically showing an entire configuration of a wireless communication system according to an embodiment of the present invention;

FIG. 2 is a block diagram showing an internal configuration of the controller unit in FIG. 1;

FIG. 3 is a block diagram showing an internal configuration of the communication unit in FIG. 2;

FIG. 4 is an view showing the appearance of the multifunction peripheral in FIG. 2;

FIG. 5 is a top view showing an external configuration of the operation unit in FIG. 4;

FIG. 6 is a block diagram showing an example of a configuration of the cellular phone in FIG. 1;

FIG. 7 is a block diagram showing an example of a configuration of the notebook PC in FIG. 1;

FIG. 8 is a block diagram showing an example of a configuration of the PDA in FIG. 1;

FIG. 9 is a flowchart showing a generation process of an identification information table between the multifunction peripheral and the cellular phone 300 in FIG. 1;

FIG. 10 is a view showing an example of the identification information table;

FIG. 11 is a flowchart showing an operational process when a job is executed between the multifunction peripheral and the PDA in proximity of the multifunction peripheral;

FIG. 12 is a flowchart showing an operational process when a job is executed between the multifunction peripheral and the cellular phone distant from the multifunction peripheral 200; and

FIG. 13 is a view showing an example of a determination table used for executing a selection process in a step S507 in the flowchart of FIG. 11 and a selection process in a step S607 in the flowchart of FIG. 12.

### BEST MODE FOR CARRYING OUT THE INVENTION

The present invention will now be described in detail with reference to the drawings showing preferred embodiments thereof.

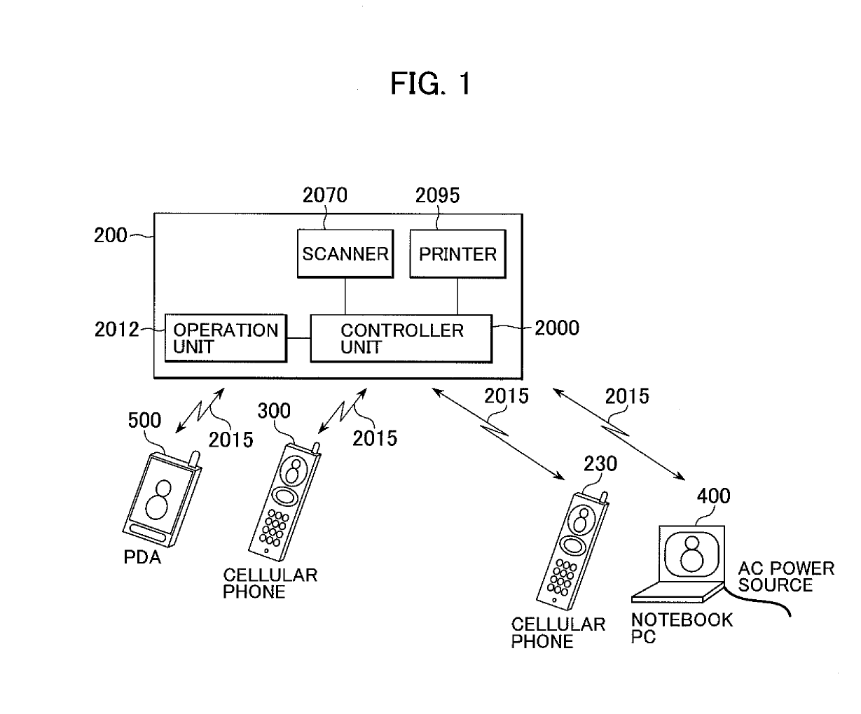

FIG. 1 is a figure view schematically showing an entire configuration of a wireless communication system according to an embodiment of the present invention.

In FIG. 1, the wireless communication system is comprised of an image input/output apparatus such as a multifunction peripheral 200 and the like, cellular phones 230, 300, a PDA (Personal Digital Assistant) 500, a portable terminal apparatus such as a notebook PC 400 and the like.

In addition to a scanning function, a printing function, a facsimile function, and a network communication function, the multifunction peripheral 200 has a wireless communication function and the like. The multifunction peripheral 200 is comprised of a scanner 2070 serving as an image input device, a printer 2095 serving as an image output device, a controller unit 2000, and an operation unit 2012 serving as a user interface.

Each of the scanner 2070, the printer 2095, and the operation unit 2012 is connected to the controller unit 2000. The controller unit 2000 has multiple wireless communication functions (wireless communication methods), and can be connected with various portable terminal apparatuses having the wireless communication functions (the wireless communication methods) such as the cellular phone 300 and the like via a radio 2015.

The wireless communication system can provide various services using the multifunction peripheral 200. For example, the wireless communication system can provide a so-called “cellular phone printing” service with which an image or a mail document stored in the cellular phones 300, 230 is transferred to the multifunction peripheral 200 via wireless and the image or the mail document is printed (an image output) by the printer 2095. The wireless communication system can also provide a so-called “push scanning” service with which an image is read out (an image input) by the scanner 2070 of the multifunction peripheral 200 and the obtained image data is transferred and stored to the notebook PC 400 and the like via wireless.

Furthermore, the wireless communication system can provide a so-called “scan to e-mail” service with which an image is read out by the scanner 2070 of the multifunction peripheral 200 and the obtained digital data is delivered via mail. In this service, a user can, for example, select a desired e-mail address from an address book registered in the PDA 500 and transmit the selected address to the multifunction peripheral 200 via wireless to specify the selected address as a destination address of “scan to e-mail”.

The controller unit 2000 selects a most suitable wireless communication means from among multiple wireless communication means according to usage conditions such as a service content, a communication range, a power source of the portable terminal apparatus, and the like, and performs a data communication with the portable terminal apparatus using the wireless communication means. For example, in a case where small data is communicated with the cellular phone near the multifunction peripheral 200, a wireless communication means is selected that has a small communication area and consumes a little electric power to be advantageous during battery operation. On the other hand, in a case where large data is communicated with a notebook PC far away that is powered by an AC power source, a wireless communication means is selected that consumes much electric power but has a large communication area and is fast.

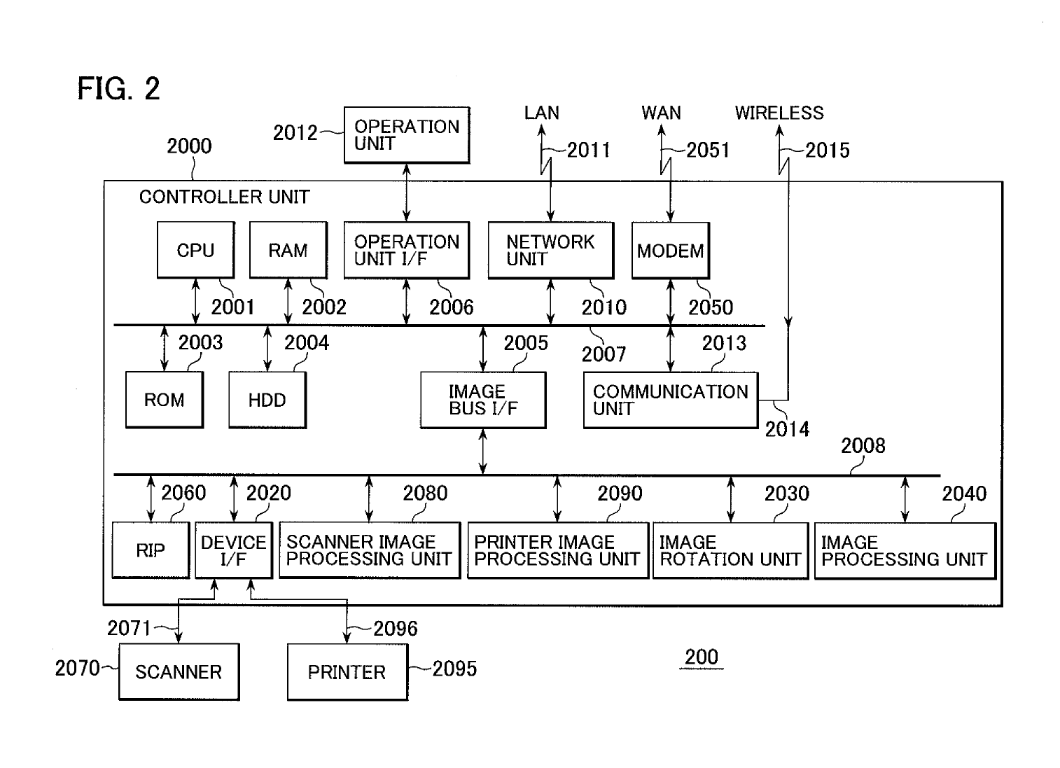

FIG. 2 is a block diagram showing an internal configuration of the controller unit 2000 in FIG. 1.

The controller unit 2000 is connected to the scanner 2070 via a bus 2071, and is connected to the printer 2095 via a bus 2096. The controller unit 2000 is also connected to other apparatuses via a LAN 2011, a public circuit (WAN) 2051, the radio 2015, and performs input and output control of image information and device information.

A CPU 2001 is a controller controlling the entire system. A RAM 2002 is a system work memory for operation of the CPU 2001, and is also an image memory for temporarily storing image data. A ROM 2003 is a boot ROM, and stores a boot program of the system. An HDD 2004 is a hard disk drive, and stores system software, the image data, and information relating to all of the wireless communication means of a communication unit 2013 (specifications of the wireless communication means), described hereinafter.

An operation unit I/F 2006 is an interface unit for the operation unit (UI) 2012, and outputs to the operation unit 2012 the image data to be displayed on the operation unit 2012. The operation unit I/F 2006 also plays a role to forward, to the CPU 2001, information that the user of this system has inputted with the operation unit 2012. A network unit 2010 is connected to the LAN 2011, and inputs and outputs information. A modem 2050 is connected to the public circuit 2051, and inputs and outputs information.

The communication unit 2013 is connected to the radio 2015 via an antenna unit 2014 connected to the communication unit 2013, and inputs and outputs information. The communication unit 2013 can perform multiple types of wireless communications. Each of the above-described devices is arranged on a system bus 2007.

An image bus I/F 2005 is connected to the system bus 2007 and an image bus 2008 transferring the image data at high speed, and is a bus bridge converting a data structure.

The image bus 2008 is a PCI bus or a bus defined in IEEE1394 and the like.

In each of the devices arranged on the image bus 2008, a raster image processor (RIP) 2060 expands a PDL code into a bitmap image. A device I/F unit 2020 connects the scanner 2070 or the printer 2095 to the controller unit 2000, and converts image data from a synchronous system to an asynchronous system and vice versa. A scanner image processing unit 2080 performs correction, processing, or editing of input image data. A printer image processing unit 2090 performs correction, resolution conversion, and the like, appropriate for the printer 2095, of print output image data. An image rotation unit 2030 rotates the image data. An image processing unit 2040 performs a compression and decompression process of the image data in JPEG, JBIG, MMR, MH, and the like and a format conversion process of the image data in PDF, TIFF, OCR, encryption, and the like.

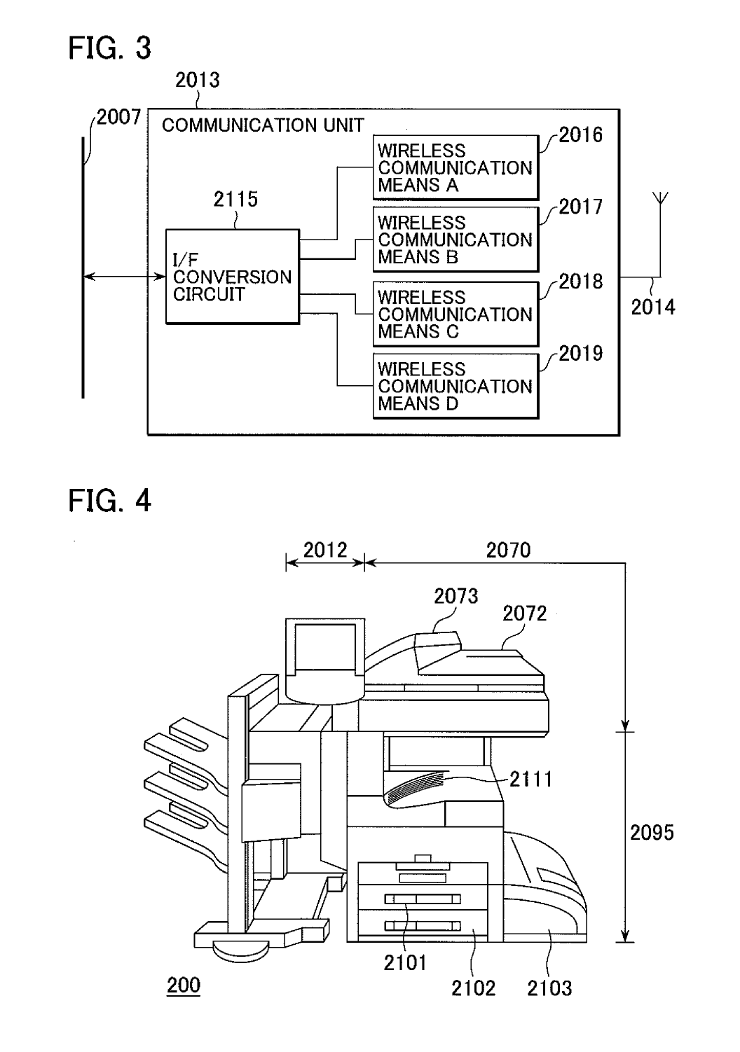

FIG. 3 is a block diagram showing an internal configuration of the communication unit 2013 in FIG. 2.

In FIG. 3, an interface (I/F) conversion circuit 2115 is connected between the system bus 2007 and multiple wireless communication means (wireless communication units) A2016, B2017, C2018, and D2019. In a case where the wireless communication means A2016 to D2019 have different interfaces (I/F) such as USB, SDIO, or the like, an I/F conversion circuit 2115 performs an interface (I/F) conversion process so that the wireless communication means adapt to the system bus 2007.

A communication range, a communication speed, power consumption, and the like are different among the wireless communication means A2016 to D2019. Each of the wireless communication means A2016 to D2019 is a wireless data communication function, for example, a proximity communication with a noncontact IC card, a spread spectrum communication such as Bluetooth, an infrared communication such as IrDA, a wireless LAN, or the like. The wireless communication means A2016 to D2019 input and output information with the radio 2015 via the antenna unit 2014. In reality, the wireless communication means A2016 to D2019 are wireless communication means different from one another, and thus, each of the wireless communication means has an antenna different from that of other wireless communication means. However, in the present embodiment, the antenna 2014 is shown as a representative for the sake of convenience.

FIG. 4 is an external view showing the appearance of the multifunction peripheral 200 in FIG. 2.

The scanner 2070 illuminates an original, moves a CCD line sensor (not shown) for scanning, converts a reflected light from the original into an electric signal as raster image data, and transmits the electric signal to the controller unit 2000 via the bus 2071. Specifically, an original is placed on a tray 2073 of an original feeder 2072, and a user gives a reading starting instruction with the operation unit 2012. When the CPU 2001 in the controller unit 2000 gives an instruction to the scanner 2070 via the bus 2071, the original feeder 2072 feeds the original sheet by sheet, and the scanner 2070 performs a reading operation of an original image.

The printer 2095 records the raster image data, received from the controller unit 2000 via the bus 2096, onto paper as an image. The methods for recording include various types such as an electrophotographic type using a photosensitive drum and a photosensitive belt, an inkjet type directly printing an image on paper by propelling ink from a minute nozzle array, and the like.

A print operation is initiated by an instruction given from the CPU 2001 in the controller unit 2000 via the bus 2096. The printer 2095 has multiple feed stages and paper cassettes 2101, 2102, 2103 corresponding to the respective feed stages so that different sizes or different paper directions can be selected. A discharge tray 2111 is a tray receiving paper finished with printing. It should be noted that recording media stored in the paper cassettes 2101, 2102, 2103 are not limited to printing paper but may be OHP sheets and the like.

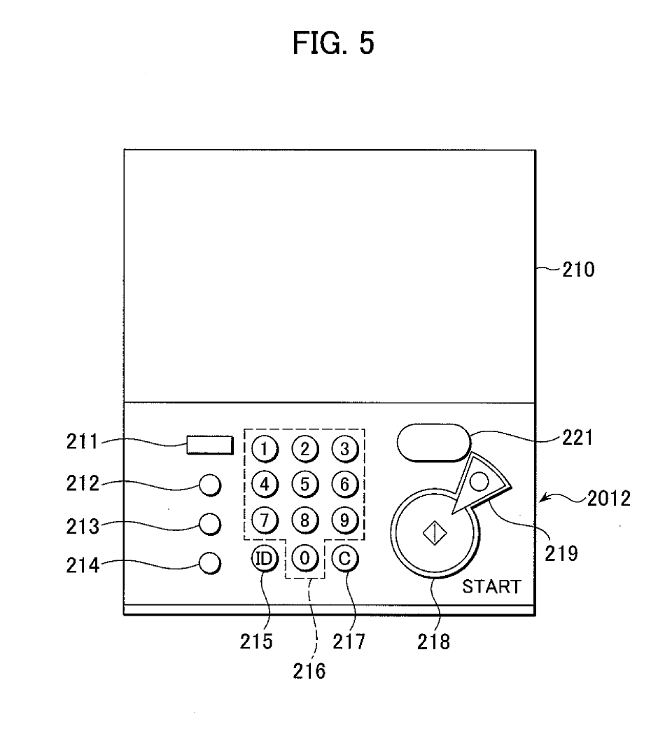

FIG. 5 is a top view showing an external configuration of the operation unit 2012 in FIG. 4.

The operation unit 2012 has a liquid crystal screen 210, a reset key 211, a guide key 212, a user mode key 213, an interruption key 214, an identification key 215, a ten key 216, a clear key 217, a start key 218, a stop key 219, and a power key 221.

The liquid crystal screen 210 is a screen for displaying set contents and operating conditions of the apparatus, and allows inputting setting information by pressing down soft keys and the like on a touch panel (not shown) arranged on the liquid crystal screen 210.

The reset key 211 is a key to reset set contents into an initial state. The guide key 212 is a key to display on the liquid crystal screen 210 a screen showing an explanation on how to operate. The user mode key 213 is a key to enter into a setting mode for making various settings of the apparatus.

The interruption key 214 is to temporarily stop operation of the apparatus so that other job operations can be executed. The identification key 215 is a key to input a password after the password is entered with the ten key 216 during a password mode in which the apparatus cannot be used without entering the password. The ten key 216 is a key to input the number of copying and to input various settings of the multifunction peripheral 200.

The clear key 217 is a key to clear an inputted value. The start key 218 is a key to input to the multifunction peripheral 200 an instruction to start an image formation operation. The stop key 219 is a key to stop an image formation operation. The power key 221 is a soft switch. Originally, the power key 221 is a key to turn on/off the power source of the multifunction peripheral 200 via software. The main power source can be turned off by, for example, pressing and holding the power key 221.

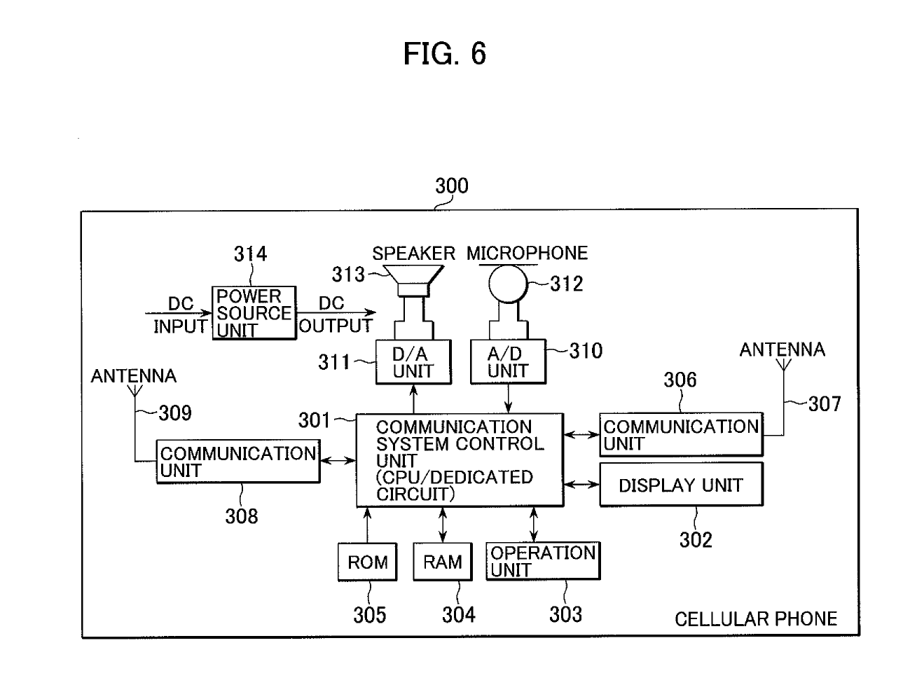

FIG. 6 is a block diagram showing an example of a configuration of the cellular phone 300 in FIG. 1.

A communication system control unit 301 is composed of a CPU and a dedicated circuit, and controls the entire cell phone 300. A ROM 305 stores a control program for the communication system control unit 301, various constants and variables for operation, software for an image display control and communication protocols (profiles) of the wireless communication means, and the like.

A RAM 304 is a working memory for the communication system control unit 301, and stores voice inputted from a microphone 312 and image data transmitted from the multifunction peripheral 200. The RAM 304 has enough capacity to store the voice data for a predetermined time and a predetermined number of the image data. Furthermore, the RAM 304 may be composed of a non-volatile memory (Flash Memory), which is electrically non-volatile, so as to store and save information about a later-described identification information table and the wireless communication means, communication circuit numbers, or the like.

A display unit 302 is composed of a liquid crystal display device (LCD) and the like. The display unit 302 displays operating conditions and messages with the image data stored in the RAM 304 and operation instruction information provided by an operation unit 303 according to an execution of a program by the communication system control unit 301.

The operation unit 303 is an operation unit for inputting various operation instructions for the communication system control unit 301, and is composed of any one of a switch and dial, a touch panel, a pointing device, and the like, or a combination thereof. With the operation unit 303, operations can be performed such as turning on/off the cellular phone 300, making/stopping a telephone call, inputting/selecting a telephone number, switching a communication mode, selecting a function, and the like.

A communication unit 306 has various long distance wireless communication functions. The antenna 307 is an antenna with which the communication unit 306 causes the cellular phone 300 to make a line connection with another communication apparatus or a communication base. A communication unit 308 has various wireless data communication functions such as a proximity communication with an IC card, a spread spectrum communication such as Bluetooth, an infrared communication such as IrDA, a wireless LAN, and the like. An antenna 309 is an antenna with which the communication unit 308 causes the cellular phone 300 to make a connection with another proximity data communication apparatus.

A microphone 312 converts an inputted voice into an analog electric signal. An A/D unit 310 converts the analog electric signal outputted from the microphone 312 into a digital signal and outputs the digital signal to the communication system control unit 301. A D/A unit 311 converts a digital signal outputted from the communication system control unit 301 into an analog signal. A speaker 313 converts the analog electric signal outputted from the D/A unit 311 into a voice signal. Based on a control of the communication system control unit 301, digital data read out of the RAM 304 is inputted to the D/A unit 311. The digital data converted by the D/A unit 311 is outputted to the speaker 313 as analog data, namely, voice data.

A power source unit 314 is composed of a DC-DC converter and the like, and generates a power source for the system from a DC power source input such as a battery (not shown).

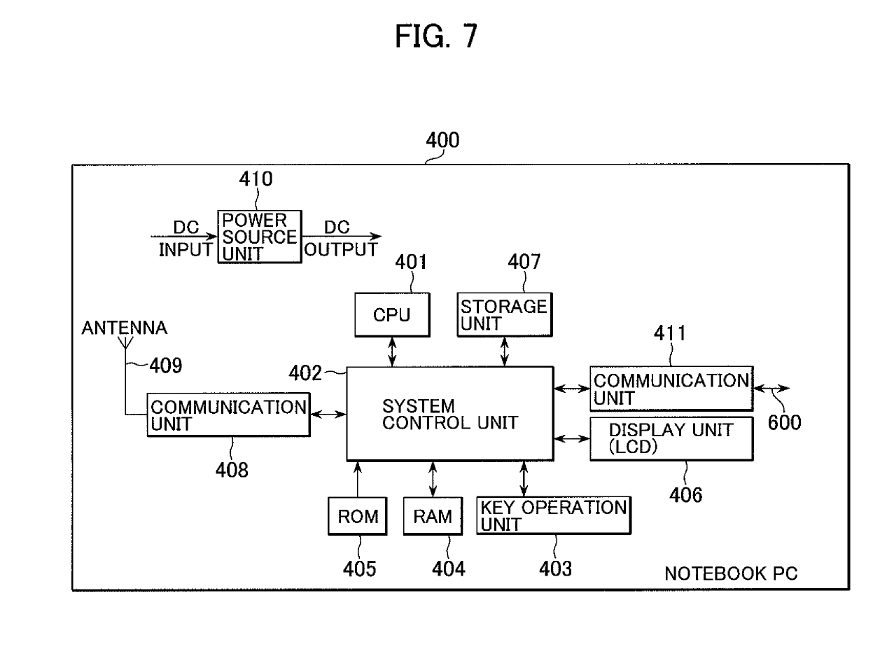

FIG. 7 is a block diagram showing an example of a configuration of the notebook PC 400 in FIG. 1.

In FIG. 7, a CPU 401 is a microprocessor controlling the entire notebook PC 400, and instructs a system control unit 402 according to a boot program (BIOS) stored in a ROM 405.

The system control unit 402 is composed of a dedicated circuit, and is a control unit in charge of controlling the entire notebook PC 400 based on an instruction of the CPU 401. The system control unit 402 writes data to a storage unit 407 and reads data therefrom, and performs controls such as transmitting display data to a display unit 406. The system control unit 402 also performs controls such as reading key instruction data from a key operation unit 403 and transmitting and receiving data to and from a communication unit 408.

The key operation unit 403 is an operation unit for inputting various operation instructions to the system control unit 402, and is composed of any one of a switch and dial, a touch panel, a pointing device, and the like, or a combination thereof. With the operation unit 403, operations can be performed such as turning on/off the notebook PC (an information processing apparatus) 400, making/stopping a telephone call, inputting/selecting information, switching a communication mode, selecting a function, and the like.

A RAM 404 is a working memory for the CPU 401 and the system control unit 402, and stores, e.g., operating condition information transmitted from the multifunction peripheral 200. The RAM 404 may be composed of a non-volatile memory (Flash Memory), which is electrically non-volatile. The ROM 405 stores a control program for the system control unit 402, a control program for booting a system, profile software such as Bluetooth, IrDA, and the like, various constants and variables for operation, and the like.

The display unit 406 is composed of a liquid crystal display device (LCD), and displays operating conditions and messages with image data stored in the RAM 404 and operation instruction information provided by a key operation unit 403 according to an execution of a program by the system control unit 402.

The storage unit 407 is composed of a hard disk device, a semiconductor memory, a memory card, and the like, and is a storage unit for temporarily storing data and storing application software. The storage unit 407 is used not only by a printing control program for, e.g., instructing to switch a printer connected to, but also used to store data transmitted to or received from the communication apparatus. The storage unit 407 can also store the system control program stored in the ROM 405.

The communication unit 408 has various wireless data communication functions such as a proximity communication with an IC card, a spread spectrum communication such as Bluetooth, an infrared communication such as IrDA, a wireless LAN, and the like. The antenna 409 is an antenna with which the communication unit 408 causes the notebook PC 400 to make a connection with another proximity data communication apparatus.

A power source unit 410 is a circuit for generating a system power source needed by various units in the notebook PC 400, and generates the power source for the system from an AC power source input. A communication unit 411 is a communication unit for connecting to a data communication network 600 such as the Internet, and a modem device is used for the communication unit 411 in a case where a telephone line network is used. In a case of directly connecting to the data communication network, a LAN adapter generally referred to as 10/100 Base-T is used. A broadband router and an ADSL modem are also used.

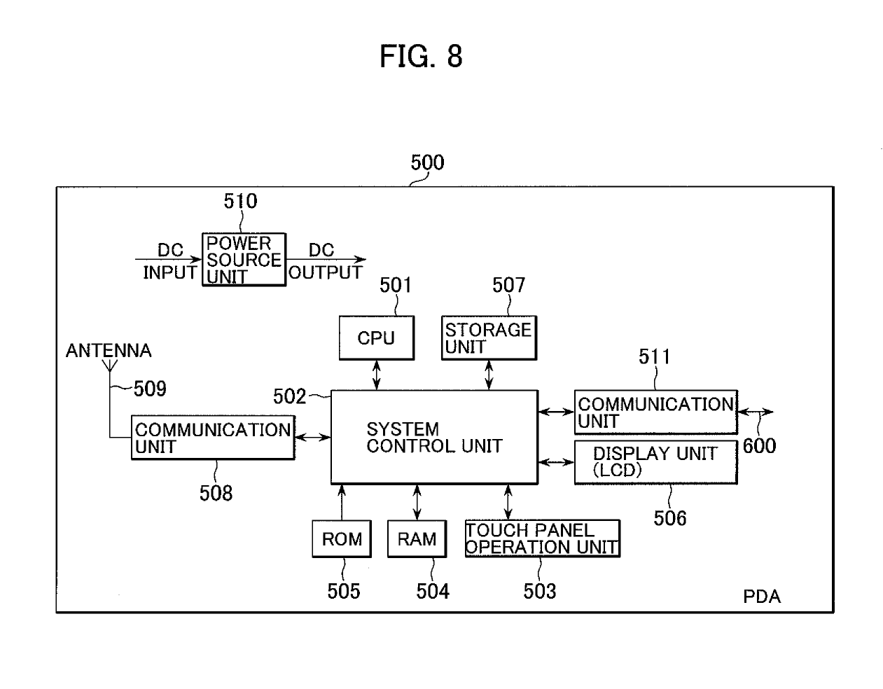

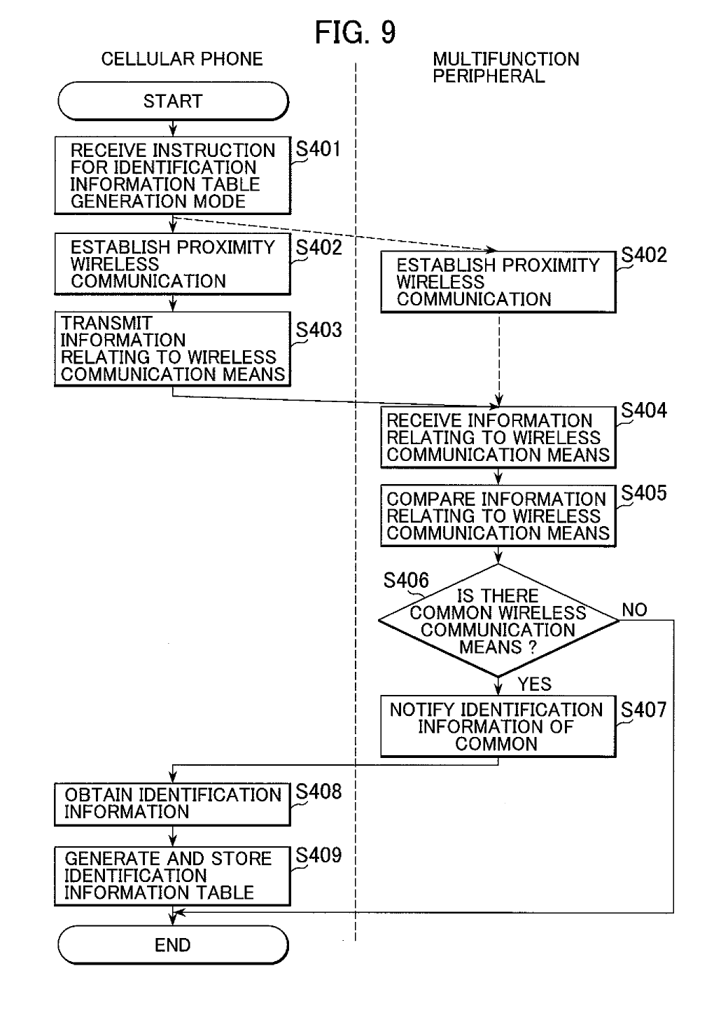

FIG. 8 is a block diagram showing an example of a configuration of the PDA 500 in FIG. 1.

A basic configuration of the PDA is similar to a basic configuration of the notebook PC described in FIG. 7. The PDA has equal functions as the notebook PC except for that the PDA is different from the notebook PC in a processing ability of a CPU 501, a physical limitation of a memory capacity, power consumption of a power source, and the like. The PDA generally uses a touch panel as an operation unit and uses a character recognition function with a stylus pen to input information and give operation instructions.

In FIG. 8, the CPU 501 is a microprocessor controlling the entire PDA 500, and instructs a system control unit 502 according to a program stored in a ROM 505.

The system control unit 502 is composed of a dedicated circuit, and is a control unit in charge of controlling the entire PDA 500 based on an instruction of the CPU 501. The system control unit 502 writes data to a storage unit 507 and reads data therefrom, and performs controls such as transmitting display data to a display unit 506. The system control unit 502 also performs controls such as reading key instruction data from a touch panel operation unit 503 and transmitting and receiving data to and from a communication unit 508.

The key control unit 503 is an operation unit for inputting various operation instructions to the system control unit 502, and is composed of a touch panel. With the operation unit 503, operations can be performed such as turning on/off the PDA 500, making/stopping a telephone call, inputting/selecting a telephone number, switching a communication mode, selecting a function, and the like.

A RAM 504 is a working memory for the CPU 501 and the system control unit 502, and stores, e.g., operating condition information transmitted from the multifunction peripheral 200. The RAM 504 may be composed of a non-volatile memory (Flash Memory), which is electrically non-volatile. The ROM 505 stores a control program for the system control unit 502, a control program for booting a system, profile software such as Bluetooth, IrDA, and the like, various constants and variables for operation, and the like.

The display unit 506 is composed of a liquid crystal display device (LCD), and displays operating conditions and messages with image data stored in the RAM 504 and operation instruction information provided by the touch panel operation unit 503 according to an execution of a program by the system control unit 502.

The storage unit 507 is composed of a memory card type hard disk device, a memory card, and the like, and is a storage unit for temporarily storing data and storing application software. The storage unit 507 is not only used by a printing control program for, e.g., instructing to switch a printer connected to, but also used to store data transmitted to or received from the communication apparatus. The storage unit 507 can also store the system control program stored in the ROM 505.

The communication unit 508 has various wireless data communication functions such as a proximity communication with an IC card, a spread spectrum communication such as Bluetooth, an infrared communication such as IrDA, a wireless LAN, and the like. An antenna 509 is an antenna with which the communication unit 508 causes the PDA 500 to make a connection with another proximity data communication apparatus. A power source unit 510 is a circuit generating a system power source needed by various units in the PDA 500, and generates the poser source for the system from a battery power source.

A communication unit 511 is a communication unit for connecting to the data communication network 600 such as the Internet, and a modem device is used for the communication unit 511 in a case where a telephone network is used. In a case of directly connecting to the data communication network, a LAN adapter generally referred to as 10/100 Base-T is used.

To use various services provided in this wireless communication system, it is assumed that identification information is obtained using the proximity communication with the IC card or the proximity wireless communication means having a small communication area such as IrDA and an identification information table is generated based on obtained identification information. The reason why the proximity wireless communication means is used is that the image input/output apparatus and the portable terminal apparatus are easily identified one-to-one. The identification information is composed of a communication range unique to the wireless communication means, a communication speed, power consumption, and the like.

It should be noted that the examples of the configurations of the cellular phone, the notebook PC, and the PDA shown in FIGS. 6 to 8 are examples of the wireless communication terminals. The wireless communication terminal is not limited to apparatus as described above as long as it is a terminal having the wireless communication function. For example, a game machine, a tablet PC, a digital camera, a portable music player, and the like are included in the wireless communication terminals if they can perform the wireless communication.

In view of the above, an identification information obtaining process between the multifunction peripheral 200 and the cellular phone 300 will be described.

FIG. 9 is a flowchart showing a generation process of an identification information table showing identification information between the multifunction peripheral 200 and the cellular phone 300 in FIG. 1.

The cellular phone 300 obtains the identification information and receives, from a user via the operation unit 303, an instruction of an identification information table generation mode for generating the identification information table (step S401). When the user inputs the instruction of the identification information table generation mode, a proximity wireless communication is established between the cellular phone 300 and the multifunction peripheral 200 (step S402). Specifically, the cellular phone 300 is placed close to the multifunction peripheral 200, and the proximity wireless communication is established between the proximity wireless communication means of the communication unit 308 in the cellular phone 300 and the proximity wireless communication means of the communication unit 2013 in the multifunction peripheral 200. For example, the user holds the cellular phone 300 over the IC card reader included in the communication unit 2013 of the multifunction peripheral 200, so that the proximity wireless communication is established between the cellular phone 300 and the multifunction peripheral 200.

When the proximity communication is established between the cellular phone 300 and the multifunction peripheral 200, the cellular phone 300 reads, based on a control of the communication system control unit 301, information relating to all of the wireless communication means possessed by the communication unit 308 from the ROM 305, and transmits the information to the multifunction peripheral 200 via the antenna 309 (step S403). It is assumed here that the information relating to the wireless communications includes information showing types of the wireless communications.

Next, when the multifunction peripheral 200 receives the information relating the wireless communication means from the cellular phone 300 (step S404), the CPU 2001 reads information relating to all of the wireless communication means possessed by the communication unit 2013 from the HDD 2004. Then, the multifunction peripheral 200 compares the information relating to the wireless communication means received from the cellular phone 300 with the information relating to all of the wireless communication means read out from the HDD 2004 (step S405).

Based on a result of the comparison in the step S405, the multifunction peripheral 200 determines whether or not there exists, in the multiple wireless communication means possessed by each of the multifunction peripheral 200 and the cellular phone 300, the common wireless communication means with which both of the multifunction peripheral 200 and the cellular phone 300 can perform data communication with each other (step S406). In a case where, as a result of the determination, the common wireless communication means does not exist with which the data communication can be performed (NO to the step S406), followed by terminating the process without generating the identification information table showing the identification between the multifunction peripheral 200 and the cellular phone 300. At this moment, the cellular phone 300 may be configured to display an error message showing that the common wireless communication means does not exist other than the proximity wireless communication means. As a result, the proximity wireless communication means becomes the only wireless communication means between the multifunction peripheral 200 and the cellular phone 300.

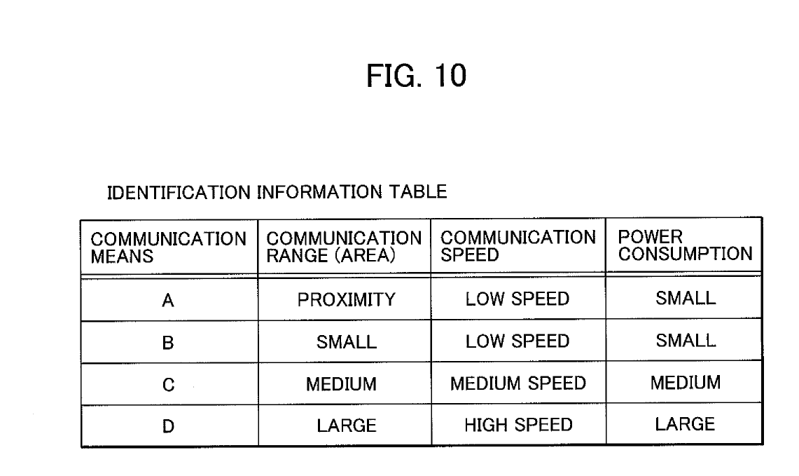

On the other hand, in a case where, as a result of the determination in step S406, there exists the common wireless communication means with which the data communication can be performed (YES to the step S406), the multifunction peripheral 200 notifies the identification information of the common wireless communication means from the multifunction peripheral 200 to the cellular phone 300 (step S407). Subsequently, the cellular phone 300 obtains the identification information (step S408). Then, the cellular phone 300 generates the identification information table in which the identification information is made into a list for each wireless communication means as shown in FIG. 10, and store the identification information table in the RAM 304 (step S409), followed by terminating the process.

It should be noted that in a case where one set of the portable terminal apparatus is used to communicate with the multiple image input/output apparatuses, the multiple image input/output apparatuses do not necessarily have an identical wireless communication means, and thus, the identification information tables different for each of the image input/output apparatuses are generated in the portable terminal apparatus. In a case where a communication is established to the wireless communication means of the image input/output apparatus for which there already exists the identification information table, setting information such as address information for specifying the image input/output apparatus is needed for establishing the wireless communication means. In such case, the portable terminal apparatus can obtain and store the setting information simultaneously with obtaining the identification information.

In the flowchart of FIG. 9, it may be configured such that the cellular phone 300 performs the processes in the steps S405 to S407. In such case, the cellular phone 300 should obtain the information relating to the wireless communication means of the multifunction peripheral 200 from the multifunction peripheral 200, instead of performing the process in the step S403.

It may be configured such that the identification information table is stored not only in the cellular phone 300 but also in the multifunction peripheral 200. For example, the identification information table generated by the cellular phone 300 in step S409 may be transmitted from the cellular phone 300 to the multifunction peripheral 200, and the multifunction peripheral 200 may store the identification information table in the HDD 2004.

It goes without saying that in the flowchart of FIG. 9, the process performed by the cellular phone 300 may be performed by the wireless communication terminal of another type (for example, the PDA 500).

FIG. 10 is a figure view showing an example of the identification information table.

In the identification information table in FIG. 10, the wireless communication means A, B, C, D including the proximity wireless communication means used to obtain the identification information are registered as the common wireless communication means with which the data communication can be performed between the multifunction peripheral 200 and the cellular phone 300. Furthermore, the identification information such as the communication range, the communication speed, the power consumption, and the like unique to the wireless communication means A to D are registered. It should be noted that the identification information is not limited to abstract descriptions shown in the figure but can be described quantitatively with numerals having specific units (such as meters, bps, Watts, and the like). By performing the flowchart of FIG. 9, the identification table of FIG. 10 can be automatically generated.

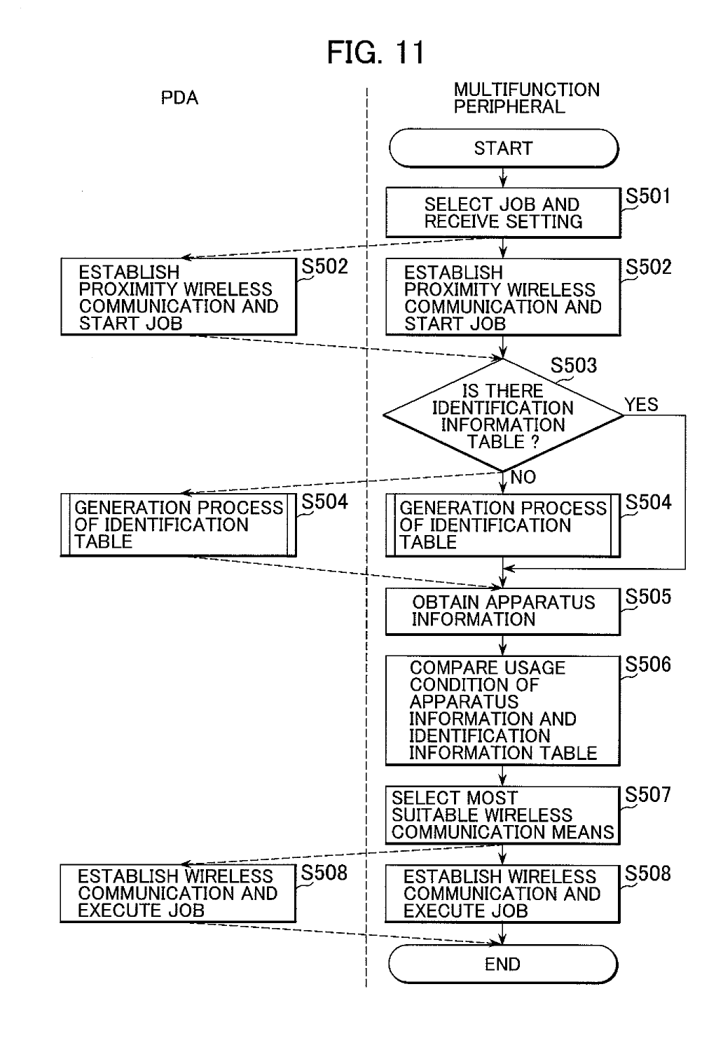

FIG. 11 is a flowchart showing an operational process when a job is executed between the multifunction peripheral 200 and the PDA 500 in proximity of the multifunction peripheral 200. In this process, an example of the operational process when the above-described “scan to e-mail” function is performed will be described.

First, the multifunction peripheral 200 receives a selection and a setting of a job from the user (step S501). In this example, after the user places an original on the scanner 2070, the user selects “scan to e-mail” with the operation unit 2012, and selects an address input mode allowing the user to specify an address. Furthermore, the user places the PDA 500 at such a distance that the proximity wireless with the multifunction peripheral is possible.

Subsequently, the proximity wireless communication is established between the PDA 500 and the multifunction peripheral 200 to start “scan to e-mail” job (step S502). Here, the user selects and displays an e-mail address for a destination from among an address book registered to the PDA 500, and places the PDA 500 in proximity of the multifunction peripheral 200. In this way, the above-described proximity wireless communication is established. This proximity wireless communication means is used when the identification information of the wireless communication means is obtained, and an establishment of this communication is a starting condition for starting the job of “scan to e-mail” function.

When the proximity wireless communication is established between the PDA 500 and the multifunction peripheral 200 and the job is started, it is determined whether or not there exists the identification information table corresponding to the multifunction peripheral 200 (step S503). Specifically, it is determined whether or not the identification information table corresponding to the multifunction peripheral 200 is stored in the RAM 504 in the PDA 500. In a case where, as a result of the determination in the step S503, there exists the identification information table corresponding to the multifunction peripheral 200 (YES to the step S503), apparatus information of the PDA 500 is obtained (step S505). The apparatus information is composed of operation setting information of a job executed via the data communication between the portable terminal apparatus and the image input/output apparatus, an electricity supplying method of the portable terminal apparatus, and power source information about a remaining amount of the battery. For example, this apparatus information is information showing usage conditions such as the fact that the communication area of the wireless communication means can be small because the job is started upon the establishment of the proximity wireless communication, the fact that a transfer data amount is small because address information for “scan to e-mail” is to be transmitted, the fact that the PDA is operated by the battery, and the like.

On the other hand, in a case where, as a result of the determination in the step S503, the identification information table corresponding to the multifunction peripheral 200 does not exist (NO to the step S503), the above-described identification information table generation process shown in FIG. 9 is performed (step S504), and thereafter, the apparatus information of the PDA 500 is obtained (step S505).

Next, the apparatus information of the PDA 500 and the identification information in the identification information table are compared (step S506), and the wireless communication means most suitable for performing the data communication is selected (step S507). The details of the step S507 will be described later in detail. For example, the wireless communication means B is selected in a case where the wireless communication means B is determined to be most suitable that has small communication area, low communication speed, and low power consumption, upon the comparison between the obtained apparatus information and the identification information in the identification information table.

Next, a communication according to the selected wireless communication means is established, and the selected job is executed (step S508). In this embodiment, the address information (the selected e-mail address) is transferred from the PDA 500 to the multifunction peripheral 200, the scanner 2070 reads an image (an image input), and the obtained digital data is delivered via e-mail through the LAN 2011. It goes without saying that in the flowchart of FIG. 11, the processes performed by the PDA 500 may be performed by the wireless communication terminal of another type (for example, the cellular phone 300).

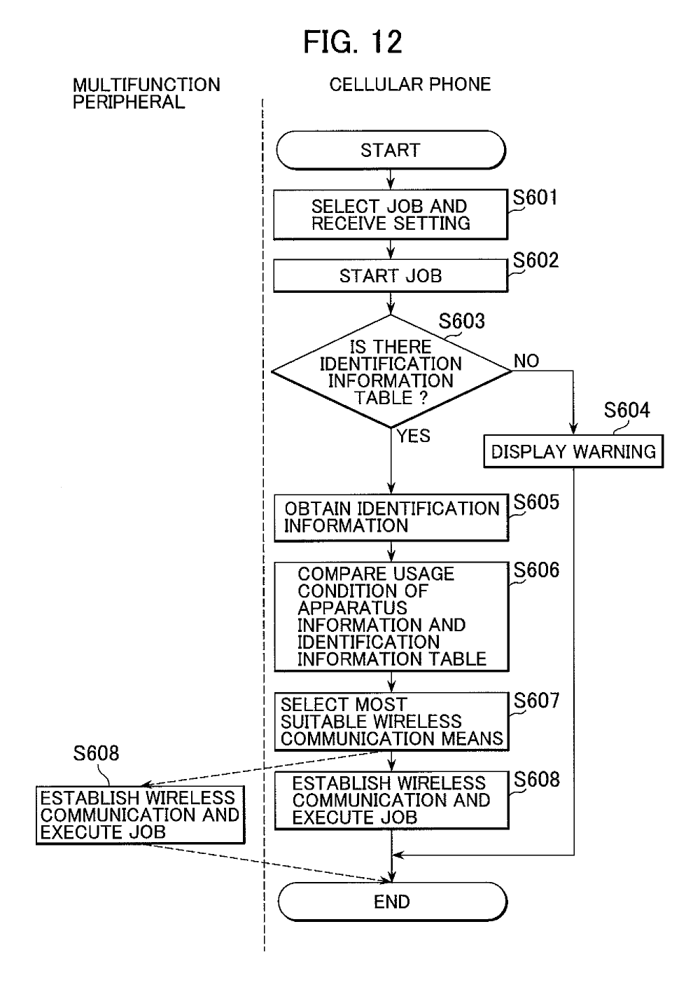

FIG. 12 is a flowchart showing the operational process when a job is executed between the multifunction peripheral 200 and the cellular phone 230 distant from the multifunction peripheral 200. In this process, an example of the operational process when the above-described “cellular phone printing” function is performed will be described.

First, the cellular phone 230 receives a selection and a setting of a job from the user (step S601). In this embodiment, the user specifies the multifunction peripheral 200 as the other communication party. Multiple images are read out of the RAM 304 in the cellular phone 230, and the user uses the operation unit 303 to select a desired image from among multiple images displayed as a list on the display unit 302, and the user instructs a printing.

When the printing is instructed, a job for print processing is started (step S602). That is, the printing instruction given on the cellular phone 230 is a starting condition for starting the job of “cellular phone printing” function. This is because this example assumes a long range communication where the cellular phone 230 and the multifunction peripheral 200 are away from each other and uses the long range wireless communication means, in contrast to the above-described proximity wireless communication means.

When the long range wireless communication is established and the job is started, the cellular phone 230 determines whether or not the identification information table corresponding to the multifunction peripheral 200 is stored or not (step S603). In a case where, as a result of this determination, the identification information table corresponding to the multifunction peripheral 200 is already stored upon the identification information table generation process of FIG. 9 (YES to the step S603), the apparatus information of the cellular phone 230 is obtained (step S605). The apparatus information is composed of operation setting information of a job executed via the data communication between the portable terminal apparatus and the image input/output apparatus, an electricity supplying method of the portable terminal apparatus, and power source information about a remaining amount of the battery. For example, this apparatus information is information showing usage conditions such as the fact that a small communication area of the wireless communication means may cause problems because the job is started upon the establishment of the long range wireless communication, the fact that a transfer data amount is rather large because multiple images are specified in “cellular phone printing”, the fact that the cellular phone is operated by a battery, and the like.

On the other hand, in a case where, as a result of the determination in the step S603, the identification information corresponding to the multifunction peripheral 200 does not exist (NO to the step S603), a warning is displayed to notify that the long distance communication cannot be performed because the identification information table has not yet been generated by the identification information table generation process of FIG. 9 (step S604). When the warning is displayed, a notification may be notified to prompt the user to execute the identification information table generation process of FIG. 9. It should be noted that, in the selection and the setting of the job in the step S601, control may be performed to give a warning when the multifunction peripheral is specified whose identification information table has not yet been obtained or to disable a selection of the multifunction peripheral whose identification information table has not yet been obtained.

Next, the usage conditions obtained from the obtained apparatus information and the identification information in the identification information table are compared (step S606), so that a most suitable wireless communication means for performing the data communication is selected (step S607). The details of the process in the step S607 will be described later in detail. For example, the wireless communication means C is selected in a case where, in the identification information table of FIG. 10, the wireless communication means C is determined to be most suitable that has medium communication area, medium communication speed, and medium power consumption.

Next, a communication according to the selected wireless communication means is established, an image is transferred to the multifunction peripheral 200, and the image is printed (image output) by the printer 2095 (step S608) (execution of the job). It should be noted that in the flowchart of FIG. 12, the process performed by the cellular phone 230 may be performed by the wireless communication terminal of another type (for example, the notebook PC 400).

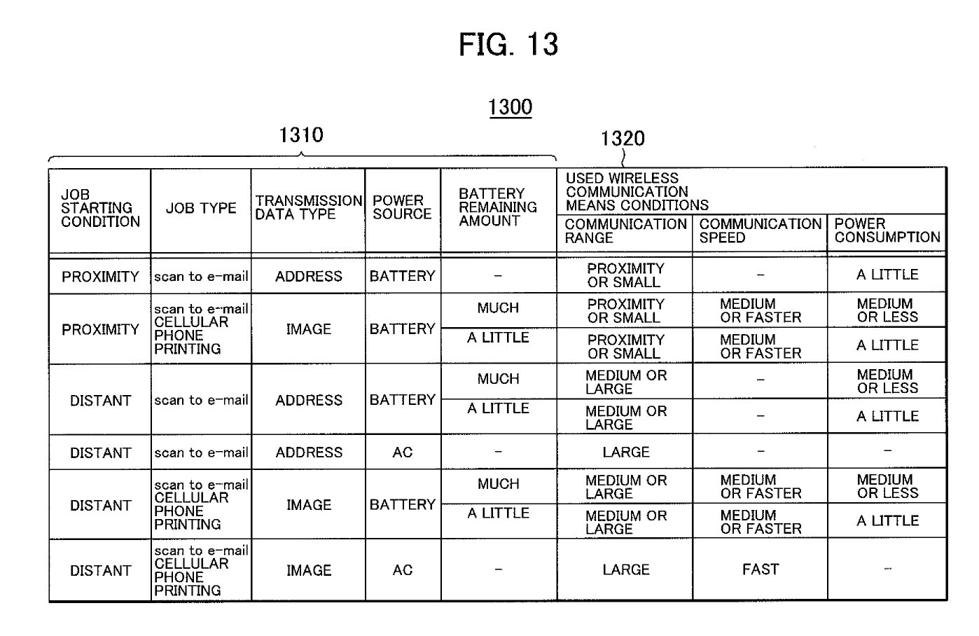

FIG. 13 is a view showing an example of a determination table used for executing the selection process in the step S507 in the flowchart of FIG. 11 and the selection process in the step S607 in the flowchart of FIG. 12. It is assumed that a determination table 1300 is stored in the HDD 2004 of the multifunction peripheral 200, the RAM 304 of the cellular phone 300, the storage unit 407 of the notebook PC, the storage unit 507 of the PDA 500, and the like.

In the selection process in the step S507 in the flowchart of FIG. 11 and the selection process in the step S607 in the flowchart of FIG. 12 (a wireless communication means selection process), the wireless communication means is selected as follows.

First, the apparatus information obtained in the steps S505 and S605 and apparatus information items 1310 in the determination table 1300 are compared, and a record having the same apparatus information is identified. Then, conditions of the wireless communication means to be selected are identified upon referring to used wireless communication means conditions 1320 corresponding to the identified record. In the present embodiment, it is assumed that three items are used as the conditions, namely, a communication range, a communication speed, and power consumption. Then, the identified conditions and the identification information table (FIG. 10) are compared, and the wireless communication means agreeing with the identified conditions is determined as the communication means to be selected in the steps S507 and S607.

For example, a case will be considered where, as the apparatus information, a type of the job is “scan to e-mail”, data to be transmitted is “address”, and the power source of the transmitting cellular phone 300 is operated by a battery. Referring to the determination table 1300, conditions are derived as the used wireless communication means conditions that the communication range is “near” or “small” and the power consumption is “low”. These conditions and the identification information table (FIG. 10) are compared, and the wireless communication means A and the wireless communication means B are to be selected.

According to the above-described embodiment, the wireless communication between the cellular phone 300 and the like and the multifunction peripheral 200 is established with the proximity wireless communication means, the identification information table is generated from the identification information of the common wireless communication means capable of the data communication among the multiple wireless communication means possessed by the multifunction peripheral 200, and the generated identification information table is stored. On the other hand, the job executed in cooperation with the cellular phone 300 and the like is started upon the establishment of the wireless communication with the proximity wireless communication means between the cellular phone 300 and the like and the multifunction peripheral 200. Then, the apparatus information of the cellular phone 300 and the like is obtained at the time of starting the job, and the apparatus information thus obtained and the identification information in the identification information table are compared, so that according to a result of this comparison, the wireless communication means for performing the data communication is selected. Thus, the wireless communication means most suitable for the user's usage conditions can be selected from the multiple wireless communication means in the wireless communication system performing the data communication between the portable terminal apparatus and the image input/output apparatus having the multiple wireless communication means, and thus, user convenience is improved.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium. In this case, the program code itself read from the storage medium realizes the functions of any of the embodiments described above, and hence the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM. Alternatively, the program may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

Moreover, it is understood that the functions of the embodiments described above may be realized not necessarily by causing the computer to read and execute the program code, but alternatively by causing an operating (OS) system running on the computer to perform part or all of the actual processes based on instructions in the program code. In this case, the program code may be supplied directly from a storage medium on which the program code is stored, or from a computer, database, or the like, not shown, that is connected via the Internet, a commercial network, a local area network, or the like.

As many apparently widely different embodiments of the present invention can be made without departing from the spirit and scope thereof, it is to be understood that the invention is not limited to the specific embodiments thereof except as defined in the appended claims.

### INDUSTRIAL APPLICABILITY

According to the present invention, the wireless communication methods most suitable for the user's usage conditions can be selected from among the multiple wireless communication methods, whereby user convenience is improved.

1. A wireless communication system wirelessly communicating between a wireless communication terminal capable of wireless communication according to a plurality of types of wireless communication methods and an image input/output apparatus capable of wireless communication according to the plurality of types of wireless communication methods, the wireless communication system comprising:
a generation unit adapted to generate information relating to a common wireless communication method that both of the wireless communication terminal and the image input/output apparatus provide; and
a selection unit adapted to select, in a case where an instruction is received that instructs to execute a job to be executed by the image input/output apparatus and the wireless communication terminal in cooperation with each other, at least one of the wireless communication methods used for executing the job, based on at least one of information relating to a type of the job and information relating to the wireless communication terminal and based on information relating to the common wireless communication method generated by the said generation unit.

2. A wireless communication system as claimed in claim 1, wherein the wireless communication terminal includes:
a transmission unit adapted to transmit, to the image input/output apparatus, information relating to the plurality of wireless communication methods provided by the wireless communication terminal; and
an acquisition unit adapted to acquire, from the image input/output apparatus, information relating to the wireless communication method enabling data communication with the image input/output apparatus,
wherein the image input/output apparatus includes:
a communication unit adapted to establish a wireless communication with the wireless communication terminal with a proximity wireless communication method, the proximity wireless communication method being one of the plurality of wireless communication methods;
a reception unit adapted to receive, from the wireless communication terminal, information relating to the plurality of wireless communication methods; and
a determination unit adapted to determine, based on the received information relating to the plurality of wireless communication methods, whether or not there exists the common wireless communication method that both of the wireless communication terminal and the image input/output apparatus provide.

3. A wireless communication system as claimed in claim 1, wherein the wireless communication terminal includes:
a control unit adapted to start a job to be executed in cooperation with the image input/output apparatus upon an establishment of a wireless communication with the image input/output apparatus with a long range wireless communication method, the long range wireless communication method being one of the plurality of wireless communication methods.

4. A wireless communication system as claimed in claim 1, further comprising a storage unit adapted to store, as identification information, the information relating to the common wireless communication method generated by said generation unit.

5. A wireless communication system as claimed in claim 4, wherein the identification information includes at information relating to at least one of a communication distance, a communication speed of the wireless communication method, and a power consumption of an apparatus using the wireless communication method.

6. A wireless communication system as claimed in claim 1, wherein the plurality of types of wireless communication methods include at least two selected from the group consisting of a proximity communication with an IC card, a spread spectrum communication, an infrared communication, and a wireless data communication.

7. A wireless communication system as claimed in claim 1, wherein the information relating to the wireless communication terminal includes operation setting information of a job executed via a data communication between the wireless communication terminal and the image input/output apparatus and power source information including a supplying method of an electric power to the wireless communication terminal.

8. A control method of controlling a wireless communication system wirelessly communicating between a wireless communication terminal capable of wireless communication according to a plurality of types of wireless communication methods and an image input/output apparatus capable of wireless communication according to the plurality of types of wireless communication methods, the control method comprising:
a generation step of generating information relating to a common wireless communication method that both of the wireless communication terminal and the image input/output apparatus provide;
a selection step of selecting, in a case where an instruction is received that instructs to execute a job to be executed by the image input/output apparatus and the wireless communication terminal in cooperation with each other, at least one of the wireless communication methods used for executing the job, based on at least one of information relating to a type of the job and information relating to the wireless communication terminal and based on information relating to the common wireless communication method generated in said generation step.

9. An image input/output apparatus capable of wireless communication according to a plurality of types of wireless communication methods, the image input/output apparatus wirelessly communicating with a wireless communication terminal capable of wireless communication according to the plurality of types of wireless communication methods, the image input/output apparatus comprising:
a generation unit adapted to generate information relating to a common wireless communication method that both of the wireless communication terminal and the image input/output apparatus provide; and
a selection unit adapted to select, in a case where an instruction is received that instructs to execute a job to be executed in cooperation with the wireless communication terminal, at least one of the wireless communication methods used for executing the job, based on at least one of information relating to a type of the job and information relating to the wireless communication terminal and based on information relating to the common wireless communication method generated by said generation unit.

10. A control method of controlling an image input/output apparatus capable of wireless communication according to a plurality of types of wireless communication methods, the image input/output apparatus wirelessly communicating with a wireless communication terminal capable of wireless communication according to the plurality of types of wireless communication methods, the control method comprising:
a generation step of generating information relating to a common wireless communication method that both of the wireless communication terminal and the image input/output apparatus provide; and
a selection step of selecting, in a case where an instruction is received that instructs to execute a job to be executed in cooperation with the wireless communication terminal, at least one of the wireless communication methods used for executing the job, based on at least one of information relating to a type of the job and information relating to the wireless communication terminal and based on information relating to the common wireless communication method generated by said generation step.

11. A computer-readable storage medium storing a program for causing a computer to execute a control method of controlling an image input/output apparatus capable of wireless communication according to a plurality of types of wireless communication methods, the image input/output apparatus wirelessly communicating with a wireless communication terminal capable of wireless communication according to the plurality of types of wireless communication methods, the control method comprising:
a generation step of generating information relating to a common wireless communication method that both of the wireless communication terminal and the image input/output apparatus provide; and
a selection step of selecting, in a case where an instruction is received that instructs to execute a job to be executed in cooperation with the wireless communication terminal, at least one of the wireless communication methods used for executing the job, based on at least one of information relating to a type of the job and information relating to the wireless communication terminal and based on information relating to the common wireless communication method generated by said generation step.
